(19) United States
(12) Patent Application Publication
(10) Pub. No.: US 2009/0158172 A1
(43) Pub. Date: Jun. 18, 2009

(54) System for making recommendations

(76) Inventors: Erik Ramsaur, Tualatin, OR (US); Michael Ramsaur, Hillsboro, OR (US); David Ramsaur, Lake Oswego, OR (US)

Correspondence Address: Timothy E Siegel Patent Law, PLLC, 601 108th Avenue, Suite 1900, Bellevue, WA, 98004, US

(21) Appl. No.: 12/002,181

(22) Filed: Dec. 14, 2007

(51) Int. Cl. G06F 3/00

(52) U.S. Cl. 715/753

(57) ABSTRACT

Systems and methods that permit an Internet user to make recommendations to other user-chosen Internet users. Users of the system described must register and obtain access to an access-controlled participant object. In a preferred embodiment the recommendation may be accompanied by a category designation, to help the automated cataloging of recommendations, and by comments.

### BACKGROUND

A person who has made a discovery will typically enjoy recommending his discovery to others and then discussing the discovery with them. This gives a group of friends a set of common experiences that bond them closer together. It has been noted that one has not truly enjoyed a new experience until he or she has shared that experiences with others.

Those surfing the Internet frequently discover fascinating new websites that they would like to share with friends. Also, it is sometimes the case that a web page is a good illustration of a newly discovered book, movie, music recording, online article or even a new recreational facility. Unfortunately, there is currently no good method of sharing discoveries of this type over the Internet.

Email is currently available. Some web pages include a button that one can press to Email the page to a friend. The screen invoked by pressing the button, however, typically does not permit one to access the address book from the user's Email program (e.g. MS Outlook or Outlook Express). Accordingly, the sender must remember or somehow access the prospective recipient's Email address. From the point of view of the recipient, the recommendation is likely to become apparent in the jumbled mass of Email that he views when he logs into his Email account. Alternatively, he may receive the Emailed recommendation when he is engaged in some other activity. When he finds the time to read the Email, it is likely be buried in an unwieldy heap in his Inbox, perhaps together with various messages encouraging him to make big money by helping a Nigerian widow smuggle billions of dollars to the United States.

At the other extreme are programs that permit a user to share a recommendation with a vast network of strangers. But the typical recommender is more likely to wish to share his recommendation with those friends that, by previous contact, he believes will appreciate the recommendation.

### SUMMARY

The systems and methods herein permit an Internet user to make recommendations to other user-chosen Internet users. Users of the system described must register and obtain access to an access-controlled participant object, where received recommendations are listed. In a preferred embodiment the recommendation may be accompanied by a category designation, either as an aid to the recipient in the categorization of the recommendation, or as an input to a system of automated cataloging of recommendations. Comments may also accompany the recommendation.

In addition to the exemplary aspects and embodiments described above, further aspects and embodiments will become apparent by reference to the drawings and by study of the following detailed descriptions.

### BRIEF DESCRIPTION OF THE FIGURES

FIG. 1 shows a computer screen that presents a browser showing a sidebar according to the present invention.

FIG. 2 shows the sidebar of FIG. 1, with the Rekommend tab selected.

FIG. 3 shows a computer screen that displays information from a user's participant object.

FIG. 4 shows a computer screen that displays the initial screen from the public pages of a website embodying aspects of the present invention.

FIG. 5 shows a flow chart describing the logic flow for a user adding contacts to his account.

FIG. 6 is a representation of a computer display of a page adapted to permit a system administration of a Rekommend.com-type system to set URL rewrite rules for web-pages sent as recommendations.

Exemplary embodiments are illustrated in referenced figures of the drawings. It is intended that the embodiments and figures disclosed herein are to be considered illustrative rather than restrictive.

### DETAILED DESCRIPTION OF THE PREFERRED EMBODIMENTS

The present invention may be embodied, in part, by a server or set of servers able to communicate with client computers and permitting the user of a client computer to perform the actions described below. This set of servers and their configuration is referred to below as “Rekommend.com.” This name, in this context, is not intended to refer to any particular legal entity, but rather to a system that is exemplary of the type of system that performs the functions described below.

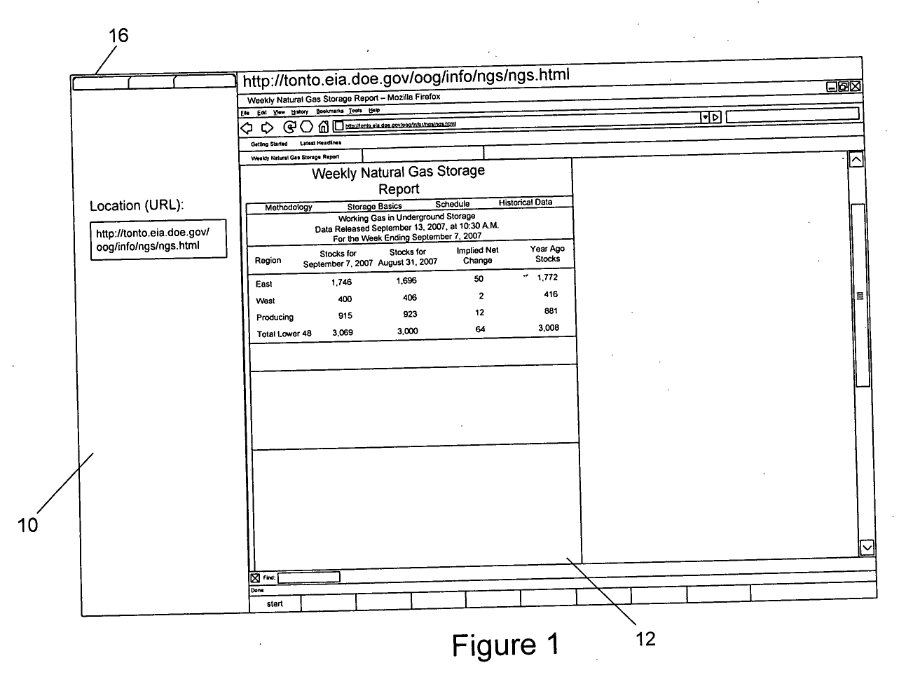

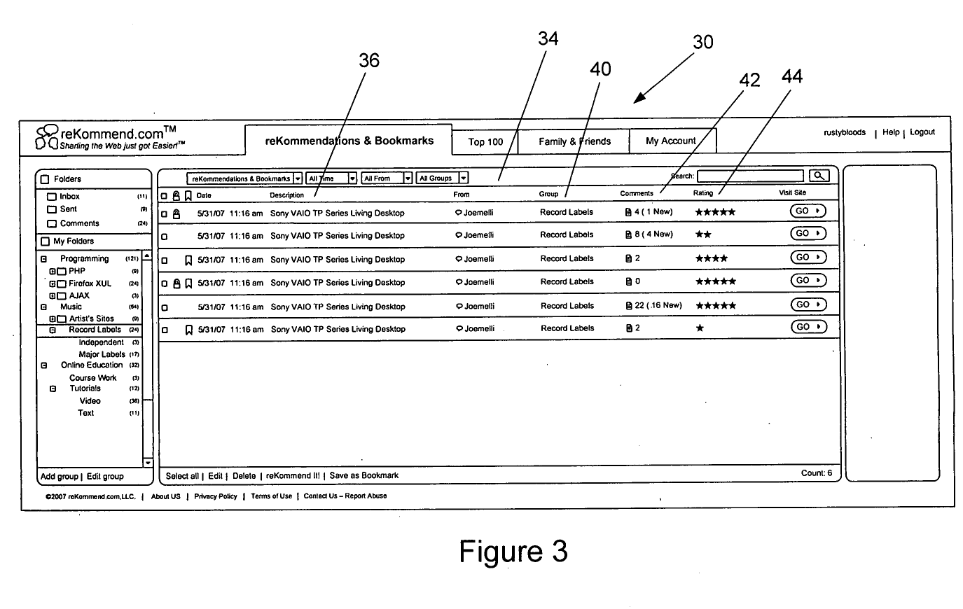

Referring to FIG. 1, in a preferred embodiment of the present invention a side bar 10 is added to a browser display 12 in a computer display screen, also displaying a webpage (not shown) to the right of the side bar 10. The side bar 10 includes a set of tabs 16 at its top that permit a user to place the side bar 10 into either rekommend mode, browse recommendations mode (described below in relation to FIG. 3) or settings mode, in which simple the user may reset his Rekommend.com password or update his profile.

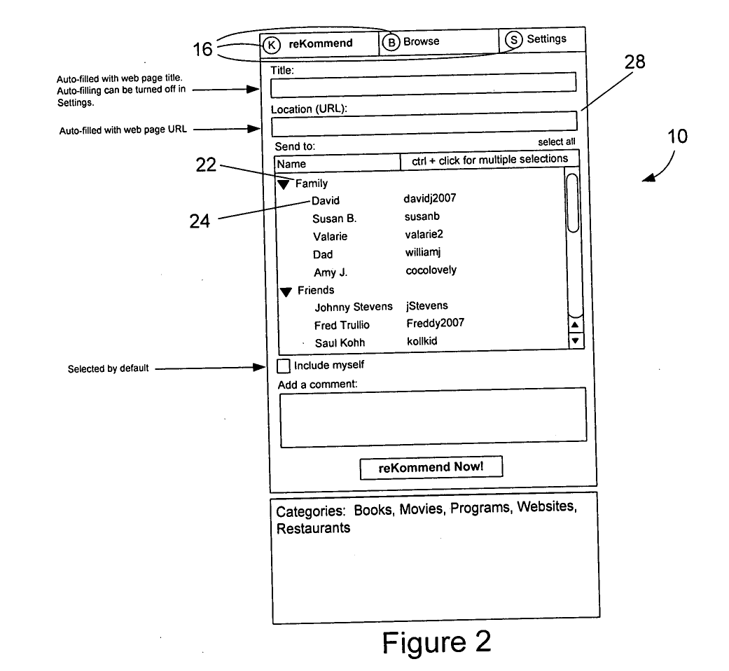

Referring to FIG. 2, in rekommend mode the side bar 10 displays both groups of contacts (shown as “Friends and Family” in the drawings), such as “Family” 22 and individual contacts, such as David 24. In a preferred embodiment, above the contact selection window 20 is a URL display window 28, which is automatically filled with the URL of the web page displayed in the remainder of screen 12. The description window is automatically filled with the title of the web page 26. This is the information that typically appears at the very top of a display screen when viewing a web page. A button labeled “Rekommend Now!” permits the user to forward a recommendation of the URL in window 28 to the participant object(s) of the designated contact(s). He may also bookmark the page, using the rekommend mode, in a sense recommending the page to himself.

With this system a user can recommend a web page to a contact or set of contacts. For example, the user could recommend an Amazon.com web page describing the book The Lord of the Flies to his family, simply by going to the web page, thereby having the URL window 24 filled in with the URL, clicking on the “family” set of contacts and clicking the “Rekommend Now!” button. A category window 30 may be available and may in the example case be filled in with the category “book,” thereby associating the word “book” with the URL for the Amazon.com page.

Referring to FIG. 3, a user may log into his participant object by entering user name and password at the home page. After he does so, and if his set of recommendations has been categorized, he is able to view a display 30 that includes a folder list 32 that permits him to choose a folder, such as “music,” a subfolder such as “record labels” and even a sub-sub folder, such as “independent” to see a set of recommendations or bookmarks. In one preferred embodiment, the folders correspond at least in part to the categories selectable by the users making recommendations using sidebar 10. In addition, the user receiving recommendations has the ability to further categorize the recommendations he has received, into a subfolder or a sub-sub folder.

The main panel 34, of display 30, lists the recommendations and provides the date of the recommendation, the description 36, the group or category 40 and the number of comments 42. In one preferred embodiment, a ranking 44 is also provided. In a preferred embodiment, the category displayed in column 40 is that which was assigned by the recommender using window 30. In a preferred embodiment the recommendation-receiver may change the category, for example to make it more specific. Alternatively, the recommender can be given no way to indicate a category, with the recommendation-receiver deciding on the category of each recommendation and originating a scheme of organization, himself.

In one preferred embodiment the system described above is implemented on a server or set of servers connected to the Internet (“Rekommend.com”). The server(s) maintain a file of participant objects, each having unique login identification. In one preferred embodiment a file permitting a sidebar to be displayed on a client computer, corresponding to one or more participant objects is downloaded at the time a participant object is opened. In a preferred embodiment, the download is a plug-in for a browser.

In this application a “contact” is a designator for a participant object, which is an Internet accessible virtual location that may be accessed by a user entering identifying information, such as a username and password. The participant object most typically resides on a server, but could be in a memory location on a particular computer in a peer-to-peer network. For example, the contact “George” appearing in a “friends and family” list, could designate the participant object that is accessed by user name “Georgeporge” and password “Kazantzakis.”

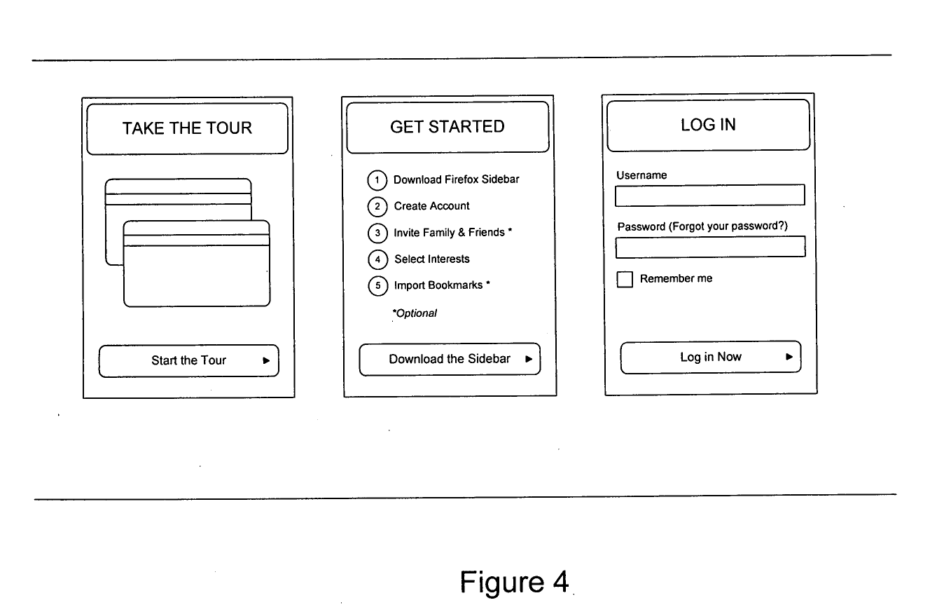

Each participant object must be initiated by a user. The user's initial contact with a Rekommend website come's either from that person visiting the initial contact page of the Rekommend.com website or by receiving an invitation from a current user. FIG. 4 shows the initial contact page 50. The contactor is given the opportunity to tour the features of the Rekommend.com system, or to download the sidebar and create an account, or to log in. Downloading the sidebar and creating an account are done in the standard way for the downloading of browser add-ons and signing up to a new website, with the new user choosing a username and a password. In a preferred embodiment the user is required to accept the end user license agreement (“EULA”) before proceeding.

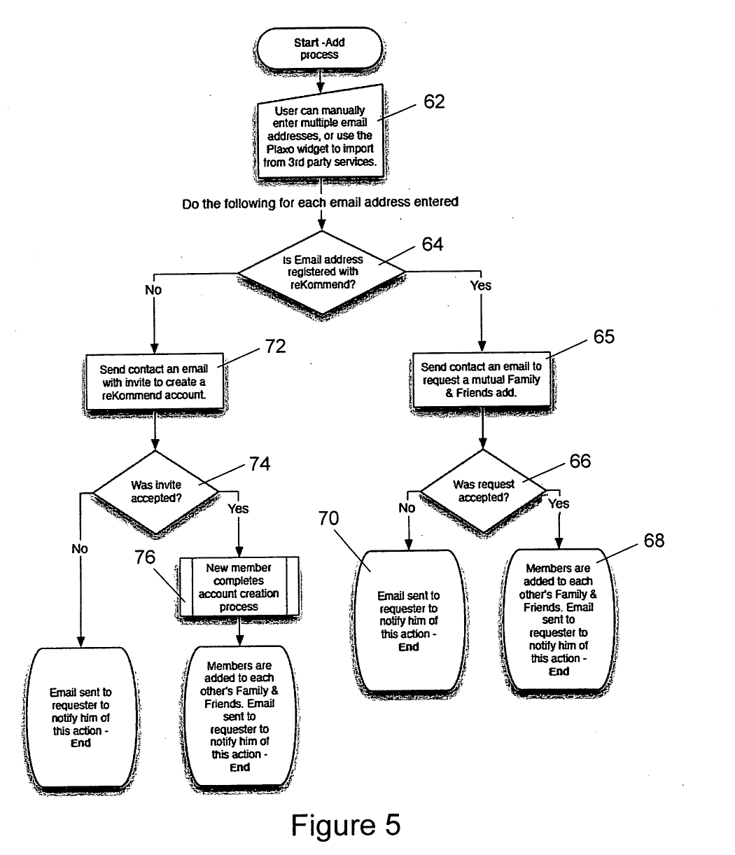

FIG. 5 shows the flow chart 60 for the logic of designating a contact. First, the user may either manually enter Email addresses, or he may use a third party software element known as “the Plaxo widget” to automatically load in the Email addresses stored in an address book, such as that associated with Microsoft Outlook or Outlook Express or other similar programs (data block 62). For each Email address, the software asks (decision box 64) whether or not the address is already registered with Rekommend.com. If the address is registered, then an Email is sent to the address asking whether or not that person wants to be on the contacts list of the requester (decision box 66). If the person does, then there is a mutual addition to the contacts lists of inviter and invitee (action block 68). Either way, the requester is notified of the invitees decision (blocks 68 and 70).

If the invitee's Email is not registered with Rekommend.com, then an Email is sent (block 72) inviting him to join and to be added to the inviter's contacts list. If the invitee accepts (decision box 72), then he is presented with the account creation screen (block 76), is added to the inviters contact list and has the inviter added (as an initial contact) to his contacts list (block 78).

When a webpage from a product seller or affiliate network, such as Amazon.com (which is a direct seller, but also forwards purchase inquiries to affiliates) is used in the recommendation, the system may append a suffix to the URL for the web page being sent. This suffix tells the product seller or affiliate network, that the purchase originated with a recommendation made using Rekommend.com. By prearrangement, the seller or affiliate network then notes this fact, and periodically forwards a payment for all of the sales that originated with a recommendation made using Rekommend.com. This system of payments may be arranged in advance and may gather funds to defray the cost of providing and updating the recommendation system and may yield a profit. In an alternative preferred embodiment, a cookie is also placed on the recommendation-recipient's computer, causing the Rekommend.com suffix to be appended to all further purchases using the product seller or affiliate network used in the recommendation, thereby by causing future purchases made from that seller to be labeled as requiring payment to Rekommend.com.

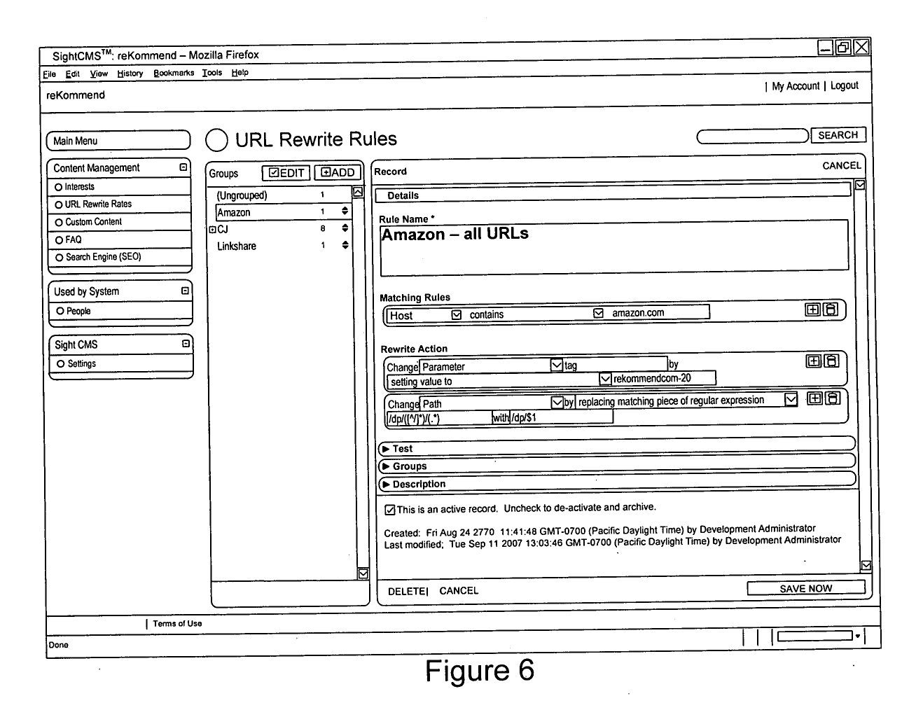

Referring to FIG. 6, a URL rewrite rules engine can be manipulated by a system administrator of the Rekommend.com system, by use of a tool, represented by the web-page shown. This tool will enable such administrators to view, search, create, update, disable, archive and delete affiliate URL rules. The affiliate URL rewrite rules enable the system to dynamically insert the Rekommend.com system affiliate keys into all links within its system that match a defined rule or rules. Rules will be based on regular expressions, with which skilled persons will have a good familiarity.

While a number of exemplary aspects and embodiments have been discussed above, those possessed of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1. A system for sharing webpage recommendations, comprising:
(a) a partial-screen display sharing a computer monitor screen with a webpage, said partial screen display including:
i) a list of participant objects designators, wherein each said designator may be selected to create a list of selected designators; and
ii) a button which when activated, sends out a link for said webpage together with a list of said selected designators.

2. The system of claim 1, that further comprises computer memory communicatively connected to said first computer monitor screen, said computer memory receiving said outwardly sent link.

3. The system of claim 2, wherein said computer memory hosts a set of participant objects, each participant object being Internet accessible to a user that enters matching identifying information.

4. The system of claim 1, including computers adapted to permit data entry of said identifying information, and adapted to send said information of the Internet to said computer memory and to then receive and display participant object information.

5. The system of claim 1, wherein said partial display includes designatable categories and wherein any category designated is sent together with said link.

6. The system of claim 1, wherein said designators are organized in user selectable groups.

7. The system of claim 1, wherein said partial screen display takes the form of a sidebar.

8. A system for sharing recommendations comprising:
(a) a network of computers having display screens;
(b) computer memory, storing:
i) a set of participant objects, and login information for each participant object designator; and
ii) a list of recommended links, for each participant object; and
(c) wherein a participant using a computer of said network of computers can login to said system by entering login information associated to a participant object and view said list of recommended links associated to said participant object.

9. The system of claim 8, wherein said recommended links are catalogued by type.

10. The system of claim 8, wherein a participant can add to a participant objects set of recommended links.

11. The system of claim 8, wherein a participant can add to any participant object's set of recommended links, including the set of recommended links associated to his own participant object.

12. Computer readable media having a computer program adapted to:
(a) cooperate with a browser program to create a partial screen display sharing a computer screen with a display for said web browser;
(b) accept participant object designators entered by a user and display said participant object designators on said partial screen display;
(c) accept the selection of participant object designators and accept a command to send a webpage recommendation to said selected participant object designators.

13. A system for generating income, comprising:
(a) a website that permits Internet users to activate an account, thereby becoming a participant and for permitting a participant to make a recommendation for an item to recommendation-receiving participants by sending to said recommendation-receiving participants a page from a merchant website offering said item for sale; and
(b) a subsystem for tracking sales made from said sent pages; and
(c) a subsystem for accepting payments from participating merchant websites, said payments being made in appreciation for facilitating sales from said merchant websites.

14. The system of claim 13, wherein said system of tracking sales includes appending a suffix to the URL for said pages, said suffix indicating that the sale should be associated with said system for generating income.

15. The system of claim 14, wherein a cookie is placed onto said recommendation-receiving participants' computers, said cookie causing said suffix to be attached to said URL whenever a said recommendation-receiving participant visits said website of said merchant associated to said page bearing said recommendation.
